(19) United States
(12) Patent Application Publication
(10) Pub. No.: US 2005/0011567 A1
(43) Pub. Date: Jan. 20, 2005

(54) Vacuum sealing-structure for heat-sinking conduit/chamber

(75) Inventor: Chin-Ching Li, Taipei (TW)

Correspondence Address: TROXELL LAW OFFICE PLLC, SUITE 1404, 5205 LEESBURG PIKE, FALLS CHURCH, VA, 22041, US

(73) Assignee: Hotmon International Corporation

(21) Appl. No.: 10/619,466

(22) Filed: Jul. 16, 2003

(51) Int. Cl. F16L 55/10

(52) U.S. Cl. 138/96 R; 138/89

(57) ABSTRACT

A vacuum sealing-structure for a heat-sinking conduit/chamber which suits an upright heat-sinking conduit (thermal tower or thermal column), a laying flat heat-sinking chamber (thermal chamber or vapor chamber) and other like devices. The structure comprises: a hollow pipe (or chamber) of which one end is open; a sealing lid for covering the opening, the sealing lid having a hole thereon; and a screw for sealing to lock in the hole of the sealing lid. Therefore, when in slight screwing in of the screw to snuggle to the hole, air in the hollow pipe (or chamber) can be drawn out by an externally connected vacuum-forming equipment, after the hollow pipe (or chamber) is drawn to form the vacuum, the screw can be screwed in to tightly seal the opening of the hollow pipe (or chamber).

### BACKGROUND OF THE INVENTION

1. Field of the Invention

The present invention is related to a vacuum sealing-structure for a heat-sinking conduit/chamber, and especially related to a vacuum sealing-structure for a heat-sinking conduit/chamber which is simple structurally, easy and fast for assembling and is detachable after sealing, it suits a heat-sinking device with heat-producing elements such as a CPU of a computer, for example, an upright heat-sinking conduit (thermal tower or thermal column), a laying flat heat-sinking chamber (thermal chamber or vapor chamber) and other articles with such seals.

2. Description of the Prior Art

The arts of computer information and manufacturing have been rapidly developed and have high value of production, they are part of important star industries; the heat-sinking products derived therefrom in the art of manufacturing the same and required by CPUs' in the global markets are estimated to be 5 to 10 billions/yr., Taiwan is estimated to require 500 millions/yr.; to see in a world-wide view, there still has quite a large latent market.

A CPU of a personal computer generates heat being due to high speed operation, to avoid overly high temperature induced by accumulation of heat to damage a CPU, heat sinking of such a CPU in a conventional system is performed forcedly by heat convection using an electrically powered fan to expel the heat absorbing from a heat source of a heat-sinking object to the inside of a sealed housing of the mainframe, this has a defect of substantial consumption of electricity and has the problems of large volume, noise and vibration as well as overly slow speed of heat sinking. In view of this, there have been vacuum conduit-devices without air impeding force used for heat sinking to largely increase the speed of heat sinking.

As shown in FIGS. 1-2a, a conventional heat-sinking vacuum conduit 1 includes an upper lid 21, a lower lid 22, they are welded to seal the top and the bottom respectively of a hollow pipe 2. The surface of the upper lid 21 is provided with a protruding member with a hole 211 for extending therein a thin pipe 3; when in an operation to draw for forming vacuum, a vacuum-forming equipment (not shown) draws air out of the hollow pipe 2 through the thin pipe 3; and after the hollow pipe 2 is in the state of vacuum, the thin pipe 3 is cut for welding and sealing, and the surface of the upper lid 21 is pressed down toward the interior of the hollow pipe 2. By the fact that the thin pipe 3 still protrudes out of the surface of the upper lid 21 after cutting, hence the upper lid 21 is applied with sealing compound (not shown) in practicing to maintain evenness of the surface of the upper lid 21.

However, the vacuum sealing-structure of the conventional heat-sinking vacuum conduit 1 still has the defects as below:

1. After drawing for forming vacuum of the conventional heat-sinking vacuum conduit 1, in the processes of cutting pipe and welding for sealing, it is hard to assure that air does not enter the hollow pipe 2; once the welding and applying of sealing compound are completed, the hollow pipe 2 is found to not reach the vacuum state, the upper lid 21 will be unable to open again to once more perform the operation of drawing for forming vacuum, thereby redundant waste can be generated to induce waste of the cost of production.

2. Sealing of the conventional heat-sinking vacuum conduit 1 shall be done through the complicated operation procedure including pressing to contact, cutting pipe and welding, and one must be careful to avoid outside air from entering the hollow pipe 2, so that working time is relatively largely increased, and silicone must be injected to maintain evenness of the surface of the upper lid 21. And even some manufacturers add another lid to the pipe 2 for the purpose of maintaining evenness; thereby the cost of production always keeps high.

In view of the above defects to be gotten rid off to lower the cost of production and increase the efficiency of production in getting the effect of vacuum, the vacuum sealing-structure for a heat-sinking conduit/chamber of the present invention thus is provided after study and development.

### SUMMARY OF THE INVENTION

The primary object of the present invention is to provide a vacuum sealing-structure for a heat-sinking conduit/chamber which is simple structurally, easy and fast for assembling.

The secondary object of the present invention is to provide a vacuum sealing-structure for a heat-sinking conduit/chamber which is detachable after sealing.

To get the above objects, the vacuum sealing-structure for a heat-sinking conduit/chamber of the present invention mainly is comprised of: a hollow pipe (or chamber) of which one end is open; a sealing lid for covering the opening on the end of the hollow pipe (or chamber), the sealing lid having a thickness and having a hole thereon; and a screw for sealing to lock in the hole of the sealing lid, a threaded shank of the screw at least has a cut area.

Thereby, when in slight screwing in of the screw to snuggle to the hole, air in the hollow pipe (or chamber) can be drawn out by an externally connected vacuum-forming equipment through the cut areas of the screw, after the hollow pipe (or chamber) is drawn to form the vacuum, the screw can be directly screwed in to tightly seal the opening.

The present invention will be apparent after reading the detailed description of the preferred embodiments thereof in reference to the accompanying drawings.

### BRIEF DESCRIPTION OF THE DRAWINGS

FIG. 1 is a perspective view showing the appearance of a conventional heat-sinking vacuum conduit;

FIG. 1a is a sectional view taken from FIG. 1;

FIGS. 2 is a perspective view showing the appearance of the conventional heat-sinking vacuum conduit after drawing to form vacuum;

FIG. 2a is a sectional view taken from FIG. 2;

FIG. 3 is perspective view showing the appearance of an upright hollow heat-sinking conduit of the present invention integrally connected therebeneath with a plate;

FIG. 4 is a perspective view showing the elements of the embodiment of the present invention;

FIG. 5 is a schematic sectional view showing partial state of the embodiment of the present invention after drawing to form vacuum;

FIG. 6 is a perspective view showing the appearance of a laying flat heat-sinking chamber of another embodiment of the present invention;

FIG. 7 is a schematic sectional view showing the elements of the laying flat heat-sinking chamber of FIG. 6;

FIGS. 8 is a schematic view showing operation of the present invention when in drawing to form vacuum.

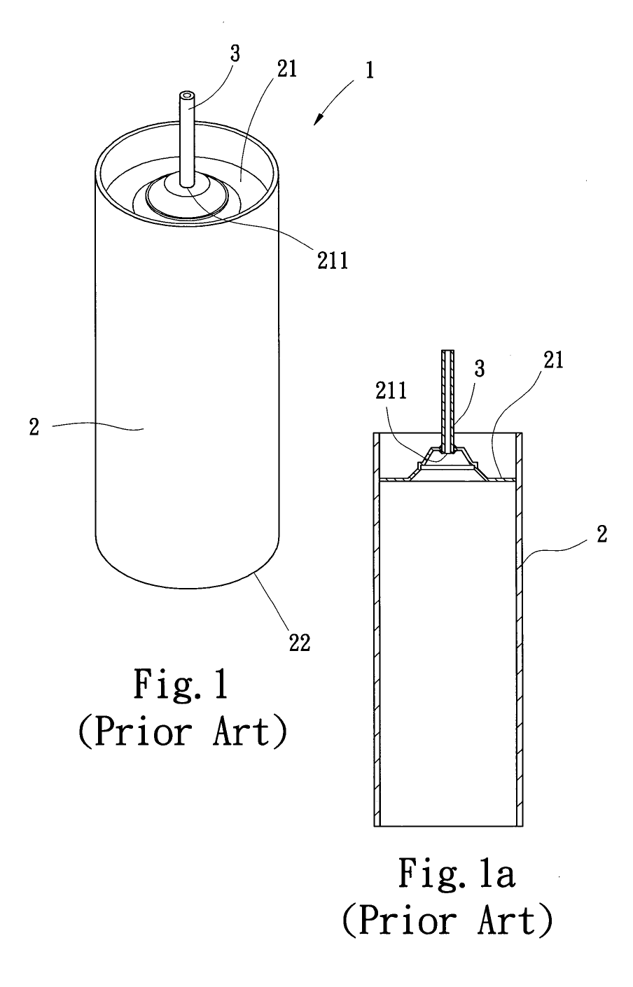

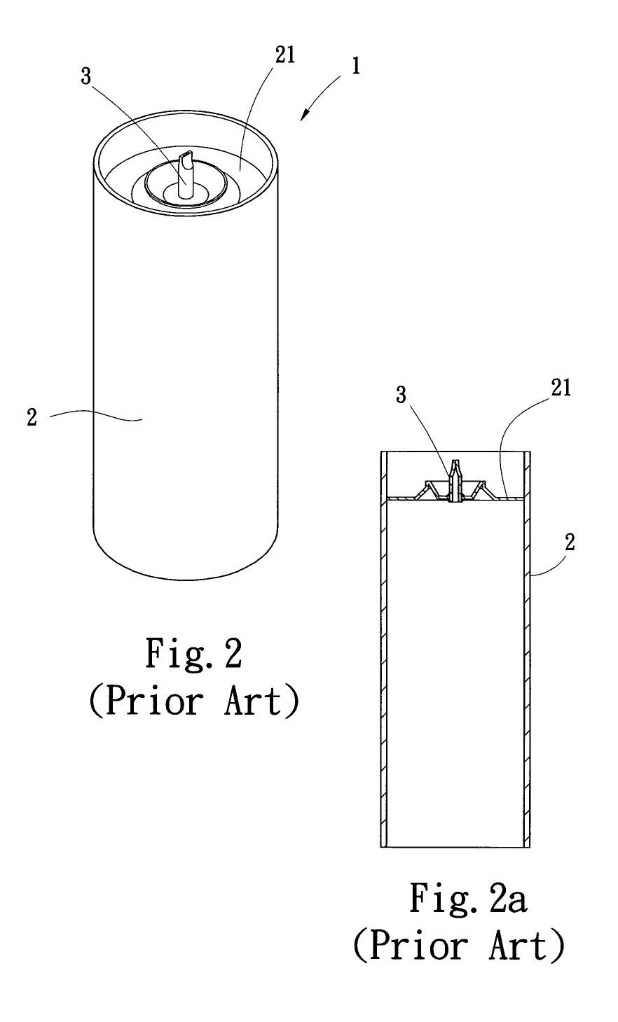

### DETAILED DESCRIPTION OF THE PREFERRED EMBODIMENT

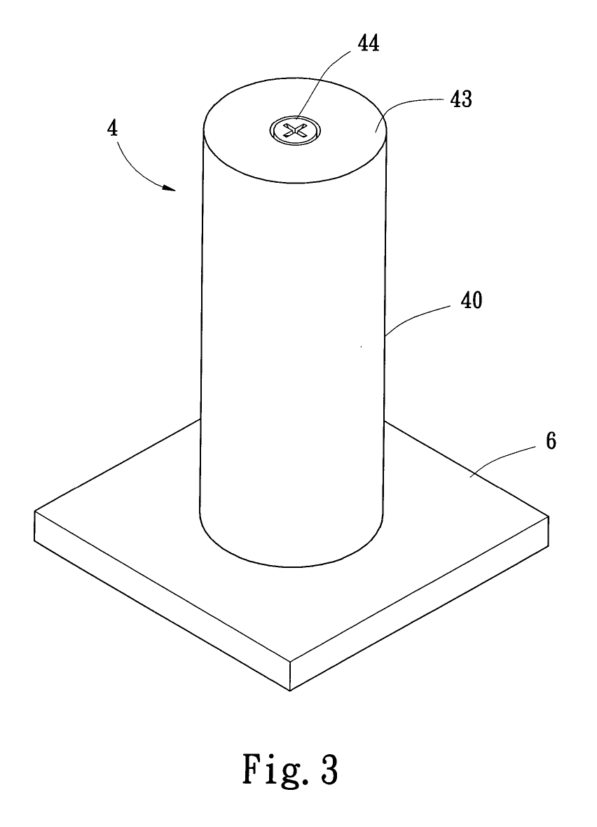

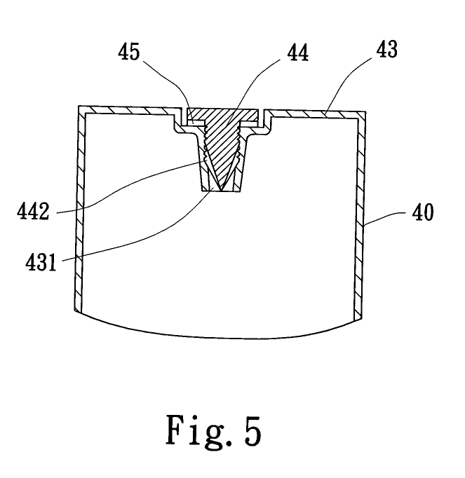

Referring to FIGS. 3-5 depicting an embodiment of an upright hollow heat-sinking conduit 4 (thermal tower or thermal column) with a vacuum sealing-structure for a heat-sinking conduit/chamber in the present invention, the embodiment includes a hollow cylindrical pipe 40, a sealing lid 43 and a screw 44 for sealing.

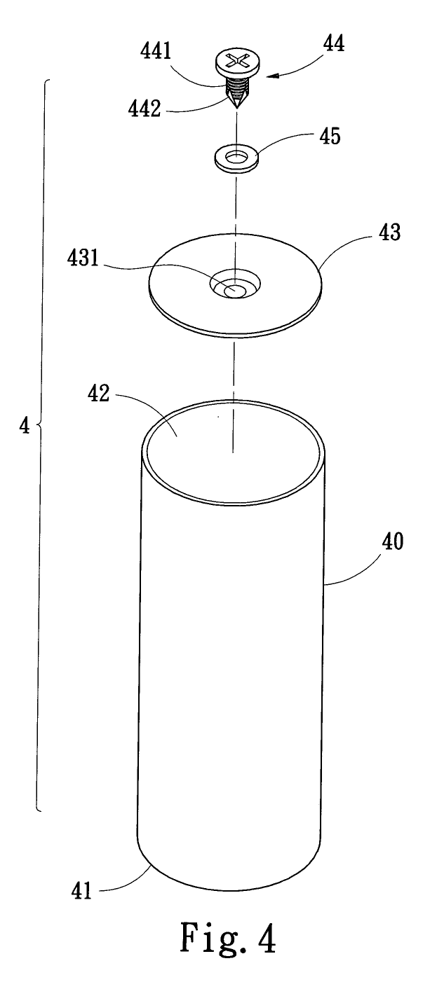

The hollow cylindrical pipe 40 has a bottom 41 on one end (referring to FIG. 4), and an opening 42 on the other end thereof.

The sealing lid 43 is welded to cover and seal the opening 42 on the aforesaid other end of the hollow cylindrical pipe 40 in the first place, the sealing lid 43 has a thickness and has a hole 431 thereon.

The screw 44 for sealing is to be locked in the hole 431 of the sealing lid 43, a threaded shank 441 of the screw 44 at least forms a cut area 442 at the location beneath the middle section of the threaded shank 441.

Therefore, when the screw 44 is slightly screwed in to snuggle to the hole 431 of the sealing lid 43, air in the hollow cylindrical pipe 40 can be drawn out by an externally connected vacuum-forming equipment 9 through the cut areas 442 of the screw 44; after the pipe 40 is drawn to form the vacuum, the screw 44 can be directly screwed in to tightly seal the opening 42.

In practicing, in order to increase the effect of air tightness, the threaded shank 441 of the screw 44 can be slipped thereover with an air-tight gasket 45 made of soft material with good heat-resistance; when in drawing for forming vacuum, the air in the hollow cylindrical pipe 40 can do inwardly absorbing, and the gasket 45 slipped over the screw 44 can be exactly absorbed to attach to the hole 431 to enhance the effect of air tightness. After sealing, the joint area of the sealing lid 43 with the screw 44 is further sealed with tin plaster or sealing compound to enhance the effect of vacuum in the pipe 40.

In addition to this, as shown in FIG. 3, the bottom 41 of the pipe 40 is integrally connected therebeneath with a plate 6 that can increase the contact area for contacting an electronic device beneath the bottom 41 of the pipe 40 to thereby increase the effect of heat sinking.

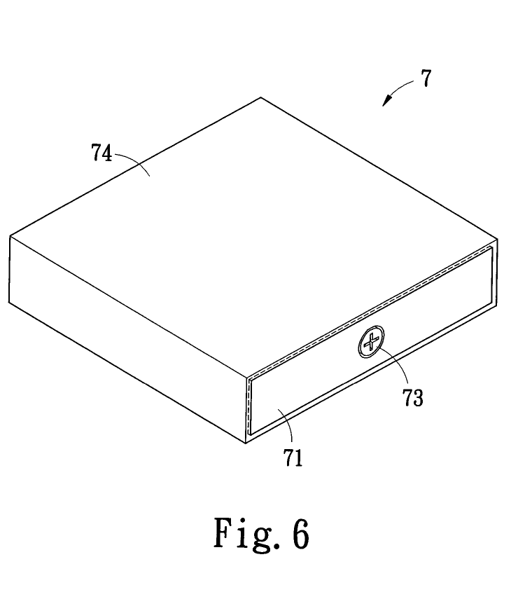

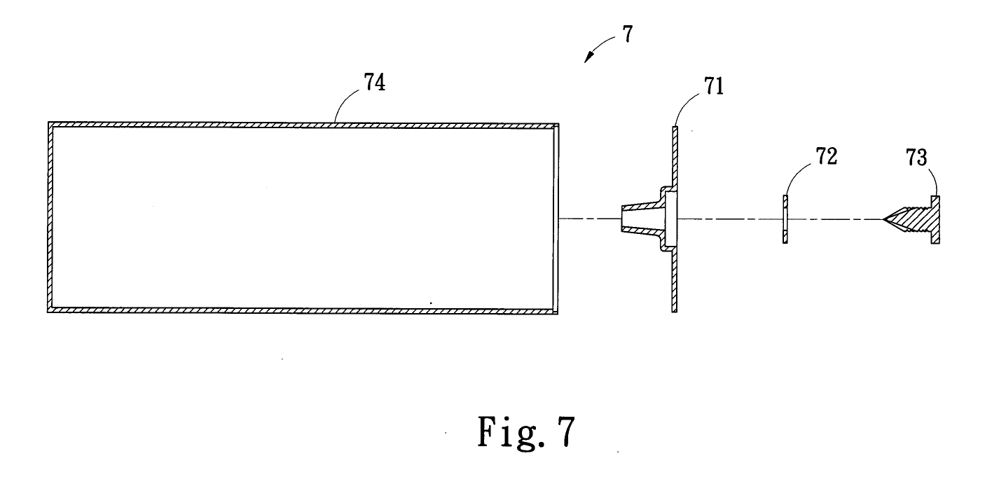

As shown in FIGS. 6 and 7, taking a laying flat heat-sinking chamber 7 (thermal chamber or vapor chamber) as another embodiment, the components and the mode of practicing of the embodiment is same as that of the aforesaid upright hollow heat-sinking conduit 4, and has a sealing lid 71, a gasket 72 and a screw 73 assembling sequentially on an opening of a chamber 74.

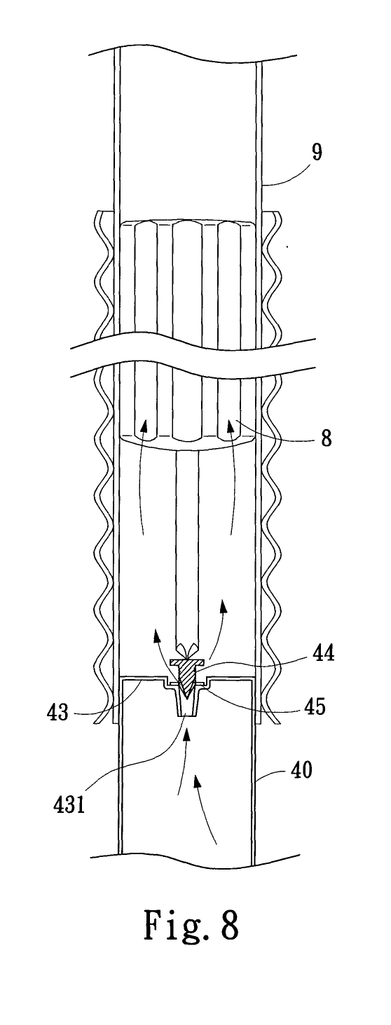

In operation of the present invention, as shown in FIG. 8, firstly the sealing lid 43 is welded to the opening 42 on the aforesaid other end of the pipe 40, then an automatic screw driver 8 is inserted into an air-drawing pipe of the externally connected vacuum-forming equipment 9; when the automatic screw driver 8 slightly screws in the screw 44 to snuggle to the hole 431 of the sealing lid 43, air in the pipe 40 is drawn out by the externally connected vacuum-forming equipment 9 (such as a pump) through the cut areas 442 of the screw 44; after the pipe 40 is drawn to form the vacuum, the screw 44 can be screwed up by the automatic screw driver 8 inserted into the air-drawing pipe of the externally connected vacuum-forming equipment 9 to tightly seal the opening 42.

When the screw 44 is screwed down to complete sealing, its surface and the surface of the sealing lid 43 together form a tidy even plane; the bottom 41 of the pipe 40 generally is connected therebeneath with the electronic device (a heat-producing article such as a CPU), hence the heat from it can be fast scattered through the vacuum pipe 40. After sealing the sealing lid 43, and in need of detaching, it needs only to release the screw 44, the sealing structure can thus be destructed; such work is very convenient.

Therefore, the present invention is advantageous as stated below:

1. After a heat-sinking conduit is drawn to form vacuum, it must be connected with some other device above it, thereby the top surface of a pipe of the conduit must be even for such connecting; a conventional sealing device has to be applied with silicone to fill to get the even surface after pipe cutting and welding during working, and even an additional lid is added, this makes the operation very complicated. In the present invention, it needs only to turn a screw into a hole of a sealing lid after drawing to form vacuum to maintain evenness of the sealing area, such work is simple and makes good appearance, and can largely reduce working hours.

2. The conventional heat-sinking conduit must have the hole of the sealing lid sealed by welding and filling glue etc. after drawing to form vacuum, once the pipe does not get the goal of the requirement for forming vacuum by negligence or some other factors, the pipe is unable to open again to once more do drawing to form vacuum; thereby much waste can be generated. While in the present invention, the screw is used to lock the pipe, whenever the above state is induced, the screw can be released immediately to do drawing to form vacuum again, hence the present invention can largely reduce cost.

3. An airtight gasket made of soft material is added between the sealing lid and the sealing screw in the present invention, so that when in drawing for forming vacuum, the gasket can be exactly absorbed to attach to the hole by the action of the air flow to enhance the effect of vacuum; when the screw is screwed up the hole, the effect of air tightness can be increased.

The above stated is only a preferred embodiment of the present invention, and not for giving any limitation to the scope of the present invention. It will be apparent to those skilled in this art that various modifications or changes made to the present invention without departing from the spirit of this invention shall fall within the scope of the appended claims.

In conclusion, according to the description disclosed above, the present invention surely can get the expected object thereof to provide a vacuum sealing-structure for a heat-sinking conduit/chamber which is simple structurally, easy and fast for assembling. Having thus described my invention with practical value, what I claim as new and desire to be secured by Letters Patent of the United States are:

1. A vacuum sealing-structure for a heat-sinking conduit/chamber, said structure comprises:
a hollow pipe (or chamber) of which one end has an opening;
a sealing lid for covering said opening on said one end of said hollow pipe (or chamber), said sealing lid having a thickness and having a hole thereon; and
a screw for sealing to lock in said hole of said sealing lid, a threaded shank of said screw at least having a cut area;
thereby, when in slight screwing in of said screw to snuggle to said hole, air in said hollow pipe (or chamber) is drawn out by an externally connected vacuum-forming equipment through said cut areas of said screw, after said hollow pipe (or chamber) is drawn to form vacuum, said screw is screwed up to tightly seal said opening.

2. The vacuum sealing-structure for a heat-sinking conduit/chamber as in claim 1, wherein the bottom of said hollow pipe is integrally connected therebeneath with a plate to render said hollow pipe to be welded onto said plate to increase heat-sinking effect.

3. The vacuum sealing-structure for a heat-sinking conduit/chamber as in claim 1 or 2, wherein said hollow pipe (or chamber) is connected therebeneath with a heat-producing article when in use.

4. The vacuum sealing-structure for a heat-sinking conduit/chamber as in claim 1, wherein said hole is provided in a recessed portion of said sealing lid; when said screw is screwed down to complete sealing, its surface and a surface of said sealing lid together form a tidy even plane.

5. The vacuum sealing-structure for a heat-sinking conduit/chamber as in claim 1, wherein said screw for sealing is slipped thereover with an airtight gasket.

6. The vacuum sealing-structure for a heat-sinking conduit/chamber as in claim 1, wherein a joint area of said sealing lid with said screw is further sealed with tin plaster or sealing compound.
